(19) United States
(12) Patent Application Publication
(10) Pub. No.: US 2015/0077503 A1
(43) Pub. Date: Mar. 19, 2015

(54) COMMUNICATION METHOD AND ELECTRONIC APPARATUS

(71) Applicants: LENOVO (BEIJING) CO., LTD., Beijing (CN); BEIJING LENOVO SOFTWARE LTD., Beijing (CN)

(72) Inventors: Dianfeng BI, Beijing (CN); Hongzhe QU, Beijing (CN)

(73) Assignees: LENOVO (BEIJING) CO., LTD., Beijing (CN); BEIJING LENOVO SOFTWARE LTD., Beijing (CN)

(21) Appl. No.: 14/230,703

(22) Filed: Mar. 31, 2014

(30) Foreign Application Priority Data
Sep. 13, 2013 (CN) 201310418706.5

(51) Int. Cl. H04N 7/14

(52) U.S. Cl. CPC H04N 7/141; H04N 7/147
USPC 348/14.07

(57) ABSTRACT

The present disclosure relates to a communication method and an electronic apparatus using the communication method. The communication method is used for a first electronic apparatus including a first image acquisition unit, and the communication method comprises monitoring a running state of the first electronic apparatus; displaying a first picture that includes a first image acquired by the first image acquisition unit when the running state satisfies a first predetermined state; and establishing a communication connection with a second electronic apparatus and displaying a second picture when the running state is switched from the first predetermined state to a second predetermined state, the second picture including a second image acquired by a second image acquisition unit of the second electronic apparatus and received via the communication connection.

### CROSS REFERENCE TO RELATED APPLICATIONS

This application claims the benefit under 35 U.S.C. §119(a) of Chinese Patent Application No. 201310418706.5, filed on Sep. 13, 2013, the disclosure of which is incorporated by reference herein in its entirety.

### TECHNICAL FIELD OF THE DISCLOSURE

The present disclosure relates to the field of video call and, more particularly, to a communication method and an electronic apparatus using the communication method.

### BACKGROUND

With the development of network communication technology and the continuous improvement of hardware performance of electronic devices, it has become popular for people to communicate with each other via the video call. In the video call technique widely used at present, a video call connection is established between a calling party and a called party once the called party accepts a video call request from the calling party. In this way, since it is only determined by the subjective judgments of the two parties whether the current instrument and environmental conditions are suitable for making the call, it often results that the pictures during the call are far from ideal after the video call connection is established, which impacts on user experience during the video call.

Therefore, it is desirable to provide a communication method and an electronic apparatus using the communication method, which are capable of providing the users with an opportunity to adjust and confirm call conditions prior to establishing a video call connection between the two parties, and thereby improving quality of pictures during the call after the video call connection is established, and enhancing user experience during the video call.

### SUMMARY

In view of the above situation, the present disclosure provides an electronic apparatus and a communication method therefor.

According to an embodiment of the present disclosure, there is provided a communication method for a first electronic apparatus including a first image acquisition unit, the communication method comprising monitoring a running state of the first electronic apparatus; when the running state satisfies a first predetermined state, displaying a first picture that includes a first image acquired by the first image acquisition unit; and establishing a communication connection with a second electronic apparatus and displaying a second picture when the running state is switched from the first predetermined state to a second predetermined state, wherein the second picture includes a second image acquired by a second image acquisition unit of the second electronic apparatus and received via the communication connection.

In addition, in the communication method according to an embodiment of the present disclosure, monitoring a running state of the first electronic apparatus, and displaying a first picture when the running state satisfies a first predetermined state comprises detecting a first operation performed by a user of the first electronic apparatus, and starting a communication application when the first operation satisfies a startup condition for the communication application, wherein the first picture is an initial interface of the communication application that includes the first image.

In addition, the communication method according to an embodiment of the present disclosure further comprises detecting a second operation performed by the user after starting the communication application, the second operation being for switching the running state from the first predetermined state to the second predetermined state.

In addition, in the communication method according to an embodiment of the present disclosure, monitoring a running state of the first electronic apparatus, and displaying a first picture when the running state satisfies a first predetermined state comprises detecting a first operation performed by a user of the first electronic apparatus, and starting a communication application and displaying a third picture when the first operation satisfies a startup condition for the communication application; and detecting a second operation performed by the user of the first electronic apparatus, sending a video call request to the second electronic apparatus and displaying the first picture when the second operation satisfies a communication request condition, wherein the first screen is a communication request sending interface of the communication application that includes the first image, and the third picture is an initial interface of the communication application that does not include the first image.

In addition, the communication method according to an embodiment of the present disclosure further comprises detecting a reception of an acceptance response with respect to the video call request from the second electronic apparatus and switching the running state from the first predetermined state to the second predetermined state after sending the video call request to the second electronic apparatus.

In addition, in the communication method according to an embodiment of the present disclosure, monitoring a running state of the first electronic apparatus, and displaying a first picture when the running state satisfies a first predetermined state comprises detecting a first operation performed by a user of the first electronic apparatus, and starting a communication application and displaying a third picture when the first operation satisfies a startup condition for the communication application; and detecting a reception of a video call request from the second electronic apparatus, and displaying the first picture, wherein the first picture is a communication request receiving interface of the communication application that includes the first image, and the third picture is an initial interface of the communication application that does not include the first image.

In addition, the communication method according to an embodiment of the present disclosure further comprises detecting a third operation performed by the user of the first electronic apparatus after receiving the video call request from the second electronic apparatus, and switching the running state from the first predetermined state to the second predetermined state when the third operation indicates to accept the video call request.

In addition, in the communication method according to an embodiment of the present disclosure, the first picture comprises a first sub-picture that displays the first image and a second sub-picture that displays an identification representative of a user of the second electronic apparatus.

Further, in the communication method according to an embodiment of the present disclosure, the second picture includes a third sub-picture that displays the second image and a fourth sub-picture that displays the first image.

In addition, in the communication method according to an embodiment of the present disclosure, a region of the first sub-picture on the first picture and a region of the third sub-picture on the second picture are the same, and a region of the second sub-picture on the first picture and a region of the fourth sub-picture on the second picture are the same.

In addition, in the communication method according to an embodiment of the present disclosure, a process that the first image enters a region to which the fourth sub-picture corresponds from a region to which the first sub-picture corresponds is displayed during the process of switching from the first predetermined state to the second predetermined state.

According to another embodiment, there is provided an electronic apparatus, comprising a processing unit for controlling various components of the electronic apparatus, and running applications and executing corresponding processes; a communication unit for performing communication with another electronic apparatus via a communication connection; an image acquisition unit for performing image acquisition under control of the processing unit; and a display unit for performing the display of an image or a video, wherein the processing unit monitors a running state of the first electronic apparatus, and controls the display unit to display a first picture that includes a first image acquired by the image acquisition unit when the running state satisfies a first predetermined state; when the running state is switched from the first predetermined state to a second predetermined state, the communication unit establishes a communication connection with another electronic apparatus, and the display unit displays a second picture that includes a second image acquired by a second image acquisition unit of another electronic apparatus and received via the communication connection.

According to still another embodiment, there is provided an electronic apparatus, comprising a component for monitoring a running state of a first electronic apparatus; a component for displaying a first picture when the running state satisfies a first predetermined state, the first picture including a first image acquired by a first image acquisition unit; and a component for establishing a communication connection with a second electronic device and displaying a second picture when the running state is switched from the first predetermined state to a second predetermined state, the second picture including a second image, wherein the second image is acquired by a second image acquisition unit of the second electronic apparatus and received via the communication connection.

In addition, the electronic apparatus according to another embodiment of the present disclosure further comprises a component for detecting a first operation performed by a user of the first electronic apparatus, and starting a communication application when the first operation satisfies a startup condition for the communication application, wherein the first picture is an initial interface of the communication application that includes the first image.

In addition, the electronic apparatus according to another embodiment of the present disclosure further comprises a component for detecting a first operation performed by a user of the first electronic apparatus, and starting a communication application and displaying a third picture when the first operation satisfies a startup condition for the communication application; a component for detecting a second operation performed by the user of the first electronic apparatus, and sending a video call request to the second electronic apparatus and displaying the first picture when the second operation satisfies a communication request condition, wherein the first picture is a communication request sending interface of the communication application that includes the first image, and the third picture is an initial interface of the communication application that does not include the first image.

In addition, the electronic apparatus according to another embodiment of the present disclosure further comprises a component for detecting a first operation performed by a user of the first electronic apparatus, and starting a communication application and displaying a third picture when the first operation satisfies a startup condition for the communication application; a component for detecting a reception of a video call request from the second electronic apparatus, and displaying the first picture, wherein the first picture is a communication request receiving interface of the communication application that includes the first image, and the third picture is an initial interface of the communication application that does not include the first image.

In addition, in the electronic apparatus according to another embodiment of the present disclosure, the first picture comprises a first sub-picture that displays the first image and a second sub-picture that displays an identification representative of a user of the second electronic apparatus; the second picture includes a third sub-picture that displays the second image and a fourth sub-picture that displays the first image; a region of the first sub-picture on the first picture and a region of the third sub-picture on the second picture are the same, and a region of the second sub-picture on the first picture and a region of the fourth sub-picture on the second picture are the same; and a process that the first image enters a region to which the fourth sub-picture corresponds from a region to which the first sub-picture corresponds is displayed during the process of switching from the first predetermined state to the second predetermined state.

The electronic apparatus and the communication method thereof according to the embodiments of the present disclosure are capable of properly providing the users with an opportunity to adjust and confirm call conditions prior to establishing a video call connection between the two parties according to their needs, and thereby improving quality of pictures during the call after the video call connection is established, and enhancing user experience during the video call.

It is to be understood that the foregoing general description and the following detailed description both are exemplary and intended to provide further explanations of the claimed technique.

### BRIEF DESCRIPTION OF THE DRAWINGS

FIG. 1 is a functional block diagram illustrating an electronic apparatus according to an embodiment of the present disclosure;

FIG. 2 is a sketchy flowchart illustrating a communication method according to an embodiment of the present disclosure;

FIG. 3 is a flowchart further illustrating a process of starting an application in a communication method according to a first embodiment of the present disclosure;

FIG. 4 is a schematic diagram illustrating a user interface after starting an application in the communication method according to the first embodiment of the present disclosure;

FIG. 5 is a flowchart further illustrating a process of requesting and establishing a communication connection in a communication method according to a second embodiment of the present disclosure;

FIG. 6 is a schematic diagram illustrating a user interface after starting an application in the communication method according to the second embodiment of the present disclosure;

FIG. 7 is a schematic diagram illustrating a user interface when requesting a communication connection in the communication method according to the second embodiment of the present disclosure;

FIG. 8 is a schematic diagram illustrating a user interface after establishing a communication connection in the communication method according to the second embodiment of the present disclosure;

FIG. 9 is a flowchart further illustrating a process of receiving a request and establishing a communication connection in a communication method according to a third embodiment of the present disclosure;

FIG. 10 is a schematic diagram illustrating a user interface when receiving a communication connection request in the communication method according to the third embodiment of the present disclosure; and

FIG. 11 is a schematic diagram illustrating an example of another possible configuration of a user interface according to an embodiment of the present disclosure.

### DETAILED DESCRIPTION

Hereinafter, multiple embodiments, applications, and modifications will be described with reference to the accompanying drawings. Furthermore, the embodiments described below are specific examples and with various technical details; however, the present disclosure is not limited to these embodiments in the following description.

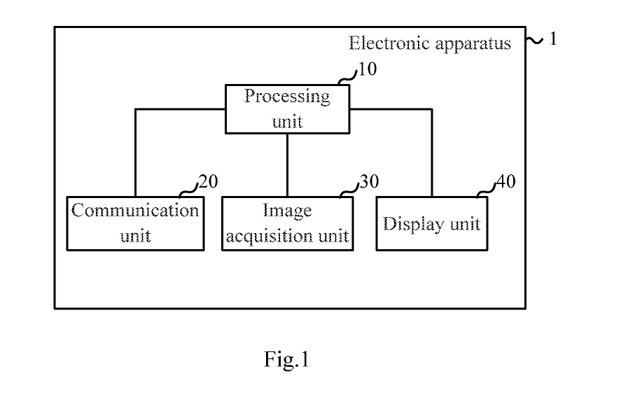

First, an electronic apparatus according to an embodiment of the present disclosure will be described with reference to FIG. 1. The electronic apparatus is for example a smart phone, a tablet PC, a laptop computer, and so on.

As shown in FIG. 1, an electronic apparatus 1 according to an embodiment of the present disclosure comprises a processing unit 10, a communication unit 20, an image acquisition unit 30, and a display unit 40. As can be easily appreciated. FIG. 1 shows only components closely related to the present disclosure to simplify description. Of course, the electronic apparatus 1 according to an embodiment of the present disclosure may further include other components such as an input unit, a power supply unit etc.

Specifically, the processing unit 10 in the electronic apparatus 1 shown in FIG. 1 is used for controlling various components of the electronic apparatus 1, and running an operating system, applications and executing corresponding processes. The communication unit 20 is used for performing communication with another electronic apparatus via a communication connection. The communication unit 20 performs communication with another apparatus in either a wire manner (e.g., via a cable or a contact physical interface etc.) or a wireless manner (e.g., via network protocols that are compliant to standards such as IEEE 802.11a, 802.11b and 802.11g etc., RF (radio frequency), or Bluetooth). The image acquisition unit 30 is used for performing the acquisition of an image or a video under control of the processing unit. The display unit 40 is used for performing the display of an image or a video.

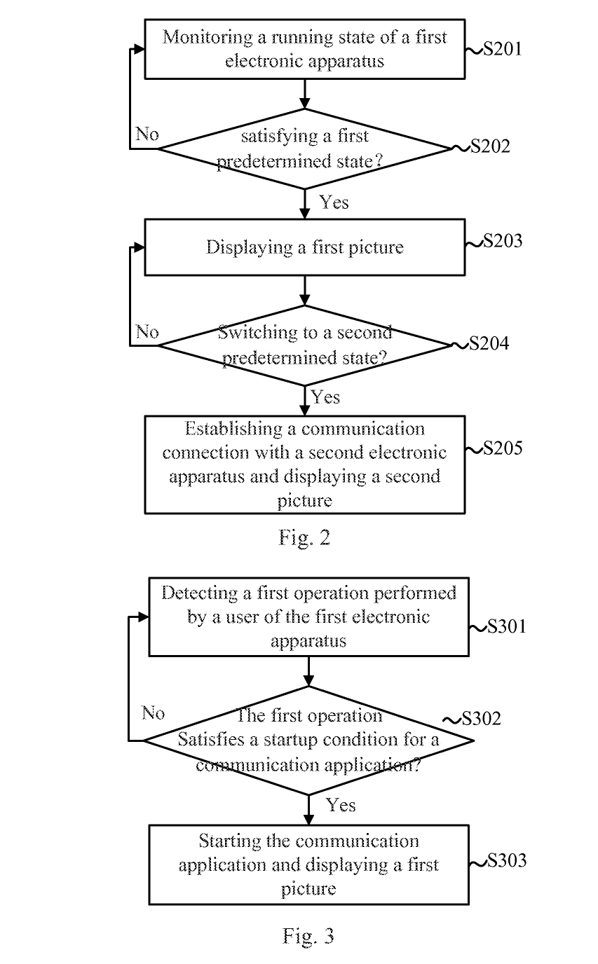

The electronic apparatus 1 according to an embodiment of the present disclosure is described with reference to FIG. 1 in the above, and a communication method adopted by the electronic apparatus 1 according to an embodiment of the present disclosure will be described with reference to FIG. 2 below.

FIG. 2 is a sketchy flowchart illustrating a communication method according to an embodiment of the present disclosure. As shown in FIG. 2, the communication method according to an embodiment of the present application comprises the following steps:

Step S201, wherein a running state of the electronic apparatus 1 is monitored; herein, the running state refers to such a state in which whether a command input of a user or a request from another apparatus is received. Thereafter, the processing proceeds to step S202;

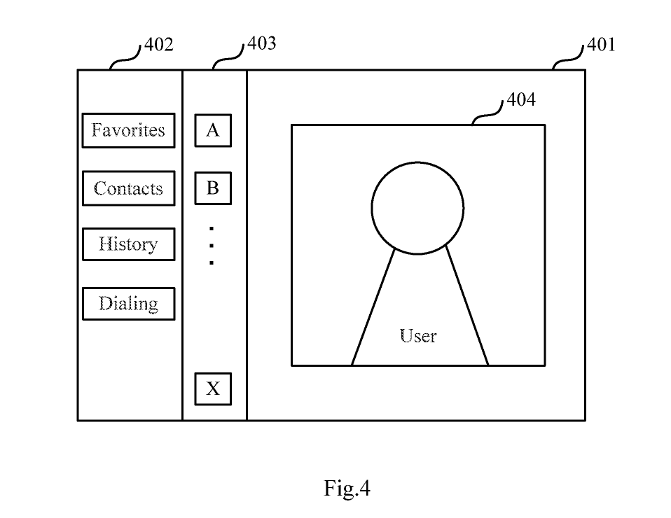

Step S202, wherein it is determined whether a detected running state satisfies a first predetermined state. Generally, the first predetermined state is a state that satisfies a startup condition for a communication application. Specific examples of the first predetermined state according to the first to the third embodiments of the present disclosure will be further described in detail with reference to FIGS. 3, 5, and 9 below.

If a positive result is obtained in step S202, that is, the detected running state satisfies the first predetermined state, then the process proceeds to step S203.

In step S203, a first picture that includes a first image acquired by the image acquisition unit 30 is displayed. Typically, the first image is an image of a local user as acquired by the image acquisition unit 30. Thereafter, the processing proceeds to step S204.

Conversely, if a negative result is obtained in step S202, the process returns to step S201, to continue to monitor the running state of the electronic apparatus 1.

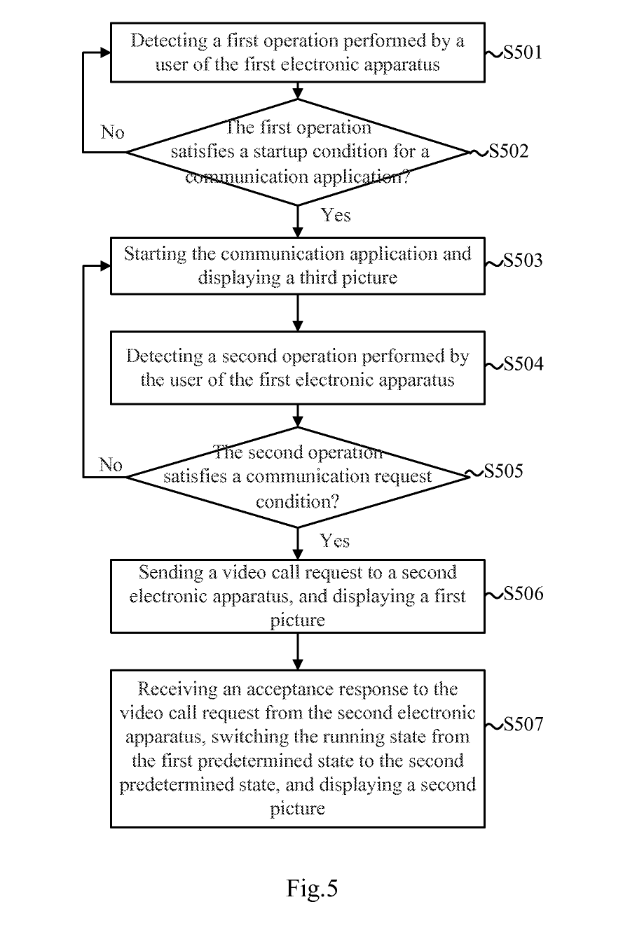

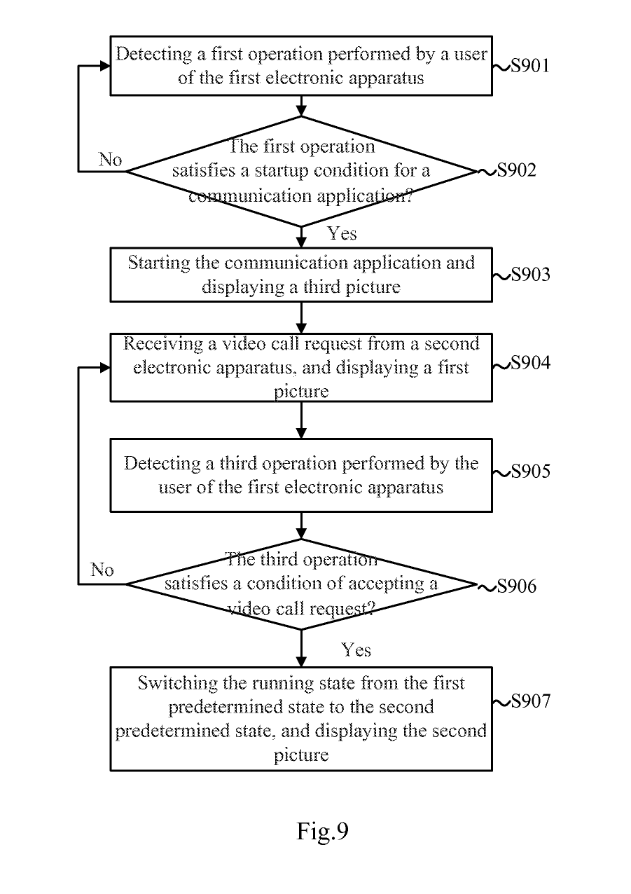

In step S204, it is determined whether the running state needs to be switched from the first predetermined state to a second predetermined state. Typically, the second predetermined state is a state of establishing a communication connection with another electronic apparatus via the communication application. Specific examples of the second predetermined state according to the first to the third embodiments of the present disclosure will be further described in detail with reference to FIGS. 5 and 9 below.

If a positive result is obtained in step S204, that is, the running state needs to be switched from the first predetermined state to the second predetermined state, then the process proceeds to step S205.

In step S205, the communication connection with another electronic apparatus is established, and a second picture is displayed. Generally, the second picture includes a second image, which is acquired by a second image acquisition unit of the second electronic apparatus and is received via the communication connection.

The sketchy process of starting a communication application and establishing a communication connection with another electronic apparatus according to the communication method of an embodiment of the present application to perform communication is described with reference to FIG. 2. Hereinafter, the communication method and corresponding user interfaces according to the first to the third embodiments of the present disclosure will be further described in detail with reference to FIGS. 2 to 11.

FIG. 3 is a flowchart further illustrating a process of starting an application in a communication method according to a first embodiment of the present disclosure.

That is to say, in the communication method according to the first embodiment of the present disclosure, steps S201 to S203 described above with reference to FIG. 2 further specifically comprise:

Step S301, in which a first operation performed by a user of the electronic apparatus 1 is detected; wherein the user of the first electronic apparatus may perform the first operation for inputting a corresponding instruction to the first electronic apparatus 1 by means of a touch screen, a keyboard, a voice input etc.; thereafter, the processing proceeds to step S302;

Step S302, in which it is determined whether the first operation satisfies a startup condition for a communication application;

If a positive result is obtained in step S302, that is, the user instructs to start the communication application, the process proceeds to step S303.

Conversely, if a negative result is obtained in step S302, then the process returns to S301. Accordingly, it continues to wait for a detection of an operation that satisfies a startup condition for a communication application. Meanwhile, the electronic apparatus 1 executes an operation corresponding to the instruction that has already been indicated by the user.

Step S303, in which the electronic apparatus 1 starts the communication application and displays a first picture; wherein the first picture is an initial interface of the communication application that includes the first image.

FIG. 4 is a schematic diagram illustrating a user interface after starting an application in the communication method according to the first embodiment of the present disclosure. That is to say, FIG. 4 illustrates the user interface 401 (i.e., the first picture) displayed on the display unit 40 after the processing in step S303 is executed.

As shown in FIG. 4, after the communication application is started, the user interface 401 contains three regions. A menu bar region 402 displays thereon menu options such as “Favorites”, “Contacts”, “History Dial”, “Dialing” etc. of the communication application. As will be easily appreciated by a person skilled in the art, menu options in the menu region 402 are not limited thereto; the aforesaid are illustrated only as examples. A sub-menu bar region 403 displays thereon a sub-menu bar after a certain menu option in the menu bar region 402 is selected. In the example shown in FIG. 4, a sub-menu of the selected menu “Contacts” is displayed, wherein “Contact A”, “Contact B” through to “Contact X” are displayed thereon.

In addition, the first image 404 is displayed on the user interface 401 (i.e., the first picture). As shown therein, the first image 404 is an image of a local user as acquired by the image acquisition unit 30.

In this way, after the user starts the communication application, a current image captured by the image acquisition unit 30 (e.g., a camera) is displayed on the initial user interface 401 for the user, thereby the user can know the picture quality, light, and angle of the image acquisition unit 30 at that moment, so as to facilitate the user adjusting acquisition parameters of the image acquisition unit 30, display parameters of the display unit 40, and his/her own postures and facial expressions and so on as needed. Further, by means of displaying the current image after the communication application is started, the user can immediately be aware of whether there is a fault in the associated components, and be provided with a corresponding fault alert.

The communication method and corresponding interfaces according to the first embodiment of the present disclosure are described with reference to FIGS. 3 and 4 wherein the current captured image is immediately displayed to the user after the communication application is started. Hereinafter, a communication method and corresponding interfaces according to a second embodiment of the present disclosure will be described in detail with reference to FIGS. 5 to 8, and a communication method and corresponding interfaces according to a third embodiment of the present disclosure will be described in detail with reference to FIGS. 9 and 10.

FIG. 5 is a flowchart further illustrating a process of requesting and establishing a communication connection in a communication method according to a second embodiment of the present disclosure.

In the flows shown in FIG. 5, processes of steps S501 and S502 are the same as those of steps S301 and S302 described above with reference to FIG. 3, respectively, that is, they serve for the detection of an operation for starting a communication application performed by the user of the electronic apparatus 1.

If a positive result is obtained in step S502, that is, the user instructs to start the communication application, the process proceeds to step S503.

In step S503, the electronic apparatus 1 starts the communication application and displays a third picture. Unlike the first picture displayed by the electronic apparatus 1 in step S303 as described above with reference to FIG. 3, the third picture is an initial interface of the communication application that does not include the first image. That is to say, the third picture does not include therein the image of the local user as acquired by the image acquisition unit 30.

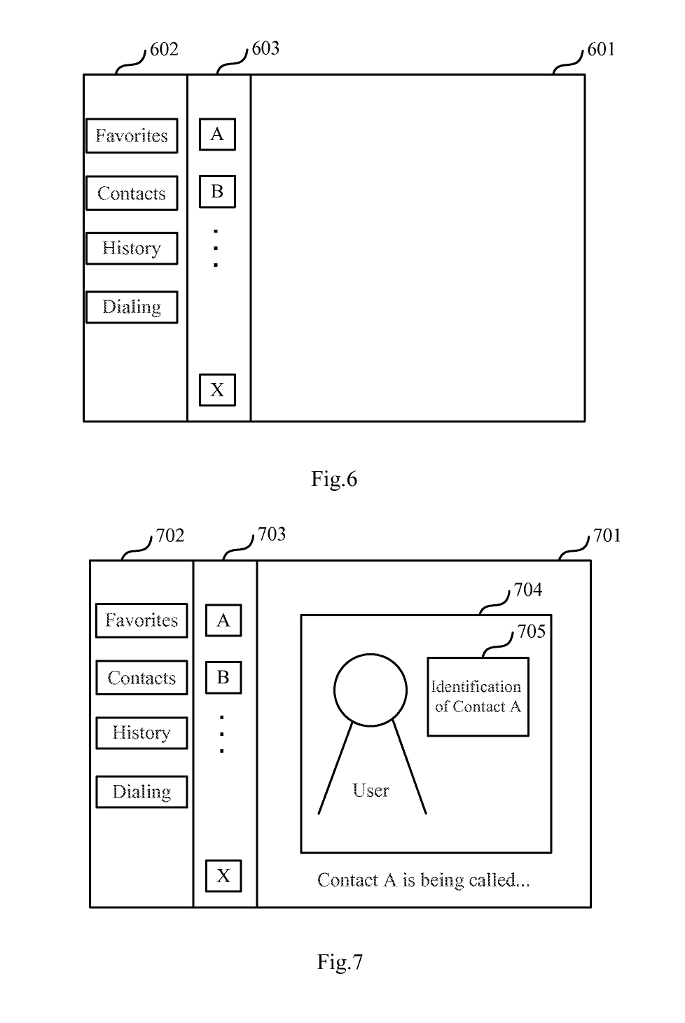

The third picture in step S503 will be described with reference to FIG. 6, which is a schematic diagram illustrating a user interface after starting an application in the communication method according to the second embodiment of the present disclosure.

As shown in FIG. 6, a menu bar region 602 and a sub-menu bar region 603 included on the user interface 601 (i.e., the third picture) displayed after the application is started in the communication method according to the second embodiment of the present disclosure are the same as the menu bar region 402 and the sub-menu bar region 403 in FIG. 4, respectively. Unlike FIG. 4, the user interface 601 shown in FIG. 6 (i.e., the third picture) does not include the image 404 of the local user as acquired by the image acquisition unit 30.

Referring back to FIG. 5, after step S503, the process proceeds to step S504.

In step S504, a second operation performed by the user of the electronic apparatus 1 is detected. As described above, the user of the electronic apparatus 1 can perform a second operation for inputting a corresponding instruction to the first electronic apparatus 1 by way of a touch screen, a keypad, and voice input etc. Thereafter, the process proceeds to step S505.

In step S505, it is determined whether the second operation satisfies a communication request condition.

If a positive result is obtained in step S505, that is, the user instructs to send a communication request, the process proceeds to step S506.

Conversely, if a negative result is obtained in step S505, the process returns to S503. Accordingly, it continues to wait for and detect an instruction to be performed by the user of the electronic apparatus 1 with respect to the communication application, so that the electronic apparatus 1 executes an operation corresponding to an instruction as already indicated by the user.

In step S506, that is, when it is determined in step S505 that the second operation satisfies a communication request condition, a video call request is sent to a second electronic apparatus, and a first picture is displayed. As described above, the first picture is a communication request sending interface of the communication application that includes the first image, which will be described with reference to FIG. 7.

FIG. 7 is a schematic diagram illustrating a user interface when requesting a communication connection in the communication method according to the second embodiment of the present disclosure. As shown in FIG. 7, when requesting the communication connection, the user interface 701 includes four regions, wherein a menu bar region 702 and a sub-menu bar region 703 are the same as the menu bar region 402 and the sub-menu bar region 403 shown in FIG. 4, respectively.

A first image 704 is also displayed on the user interface 701 (i.e., the first picture). As shown therein, the first image 704 is an image of the local user as acquired by the image acquisition unit 30. In addition, an identification 705 of contact A to which the request is sent at that moment is also included on the user interface 701. In this case, the identification is an icon such as an avatar or the like, rather than an actual video image of contact A.

In this way, by means of displaying a current image captured by the image acquisition unit 30 (e.g., a camera) on the user interface 701 for the user when requesting the communication connection, the user can learn the picture quality, light, and angle of the image acquisition unit 30 at that moment, so as to facilitate the user adjusting acquisition parameters of the image acquisition unit 30, display parameters of the display unit 40, and his/her own postures and facial expressions and so on as needed. Further, by means of displaying the current image when requesting the communication connection, the user can immediately be aware of whether there is a fault in the associated components, and be provided with a corresponding fault alert. In addition, the identification of contact A as a target of the communication request is also displayed, which thereby enables the user to recognize more clearly a target object that is requested for the communication at that moment and to avoid selecting a contact in error.

Referring back to FIG. 5, after step S506, the process proceeds to step S507.

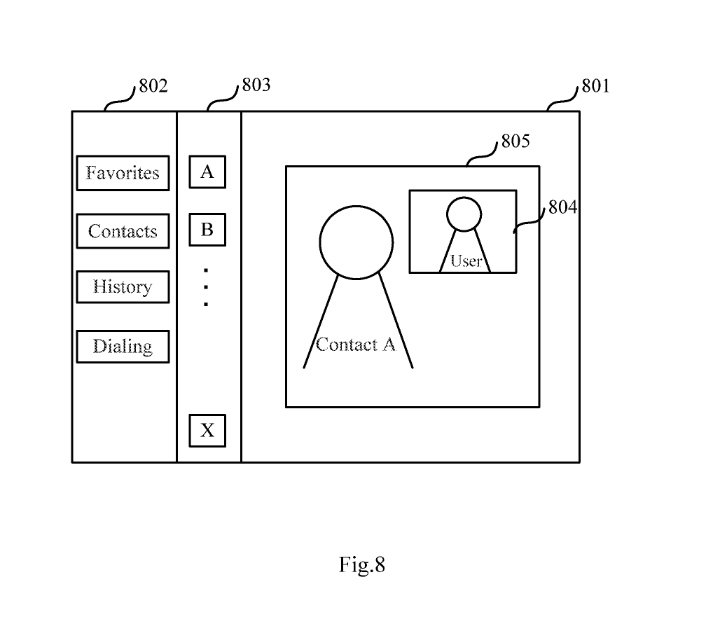

In step S507, an acceptance response with respect to the video call request from the second electronic apparatus is received, the running state is switched from the first predetermined state to the second predetermined state, and a second picture is displayed. As described above, the second picture is a communication interface of the communication application that includes the second image, wherein the second image is an image, which is acquired by a second image acquisition unit of the second electronic apparatus, received via the communication connection. This communication interface will be described with reference to FIG. 8.

FIG. 8 is a schematic diagram illustrating a user interface after establishing a communication connection in the communication method according to the second embodiment of the present disclosure. As shown in FIG. 8, after the communication connection is established, the user interface 801 includes four regions, among which a menu bar region 802 and a sub-menu bar region 803 are the same as the menu bar region 402 and the sub-menu bar region 403 illustrated in FIG. 4, respectively.

A first image 804 is also displayed on the user interface 801 (i.e., the second picture). As described above, the first image 804 is an image of the local user as acquired by the image acquisition unit 30. In addition, a second image 805 is also included on the user interface 801, and the second image 805 is an image, which is acquired by a second image acquisition unit of the second electronic apparatus, received via the communication connection. Thus, the video communication of the communication application is executed by displaying on the user interface 801 the image of the local user as acquired by the image acquisition unit 30 and the image acquired by the second image acquisition unit of the second electronic apparatus.

It should be noted that, as shown in FIGS. 7 and 8, the first image 704 in FIG. 7 and the second image 805 in FIG. 8 occupy the same region on the respective user interfaces, and the identification of contact A in FIG. 7 and the first image 804 in FIG. 8 also occupy the same region on the respective user interfaces. That is to say, they have the same position and the same display scale, respectively. Of course, the present disclosure is not limited thereto, and the relative positions and display scales between the image of the local user and the identification and image of a counterpart of the video call can be adjusted by the user as needed.

In addition, during the process of switching from the user interface in a state of sending a communication request shown in FIG. 7 to the user interface in a state of executing a video communication shown in FIG. 8, a process whereby the first image 704 enters a region to which the first image 804 corresponds from its own display region is displayed. For the sake of providing the users that are viewing this interface switching process with a better visual experience, this transition can be achieved by a corresponding animation in scale.

FIG. 9 is a flowchart further illustrating a process of requesting and establishing a communication connection in a communication method according to a third embodiment of the present disclosure.

In the flows shown in FIG. 9, the processes of steps S901 to S903 are the same as the processes of steps S501 and S503 and corresponding interfaces described above with reference to FIGS. 5 and 6, respectively, that is, they are used for detecting an operation for starting a communication application performed by the user of the electronic apparatus 1 respectively, and starting the communication application and displaying the user interface 601 shown in FIG. 6 (i.e., the third picture) after a startup condition for the communication application is met, wherein the user interface 601 does not include the image 404 of the local user as acquired by the image acquisition unit 30.

Thereafter, the process proceeds to step S904. In step S904, a video call request from the second electronic apparatus is received, and a first picture is displayed. Specifically, herein, the first picture is a communication request receiving interface of the communication application that includes the first image, which will be described with reference to FIG. 10.

FIG. 10 is a schematic diagram illustrating a user interface when receiving a communication connection request in the communication method according to the third embodiment of the present disclosure. As shown in FIG. 10, when receiving a communication request, the user interface 1001 includes four regions, wherein a menu bar region 1002 and a sub-menu bar region 1003 are the same as the menu bar region 402 and the sub-menu bar region 403 in FIG. 4, respectively.

A first image 1004 is also displayed on the user interface 1001 (i.e., the first picture). As shown therein, the first image 1004 is an image of the local user as acquired by the image acquisition unit 30. In addition, a communication identification 1005 of contact A which is sending the request at that moment is also included on the user interface 1001. In this case, the identification is an icon such as an avatar or the like, rather than an actual video image of contact A.

The user interface when receiving the communication connection request as shown in FIG. 10 and the user interface when transmitting the communication connection request as shown in FIG. 7 differ in that, on the user interface shown in FIG. 10, a prompt of “Contact A is calling in . . . ” is displayed, whereas on the interface shown in FIG. 7, a prompt of “Contact A is being called . . . ” is displayed.

In this way, by means of displaying a current image captured by the image acquisition unit 30 (e.g., a camera) on the user interface 1001 for the user when receiving the communication connection request, the user can learn the picture quality, light, and angle of the image acquisition unit 30 at that time, so as to facilitate the user adjusting acquisition parameters of the image acquisition unit 30, display parameters of the display unit 40, and his/her own postures and facial expressions and so on as needed. Further, by means of displaying the current image when receiving the communication connection request, the user can immediately be aware of whether there is a fault in the associated components, and be provided with a corresponding fault alert. In addition, the identification of contact A that initiates the communication request is also displayed, which thereby enables the user to recognize more clearly the object that initiates the communication request and to determine whether to accept this communication request according to the current situation.

Referring back to FIG. 9, after step S904, the process proceeds to step S905, in which a third operation performed by the user of the electronic apparatus 1 is detected. The user of the electronic apparatus 1 may perform a third operation for inputting a corresponding instruction to the electronic apparatus 1 by way of a touch screen, a keyboard, and voice input etc. The third operation is used for indicating whether to accept the communication request. Thereafter, the process proceeds to step S906.

In step S906, it is determined whether the third operation satisfies a condition of accepting a video call request.

If a positive result is obtained in step S906, that is to say, the user instructs to accept the video call request, the process proceeds to step S907.

Conversely, if a negative result is obtained in step S906, the process returns to S904. That is to say, the user indicates to reject the video call request, and returns to continue to wait for and detect an instruction performed by the user of the electronic apparatus 1 with respect to the communication application, so that the electronic apparatus 1 executes an operation corresponding to an instruction as already indicated by the user.

In step S907, the running state is switched from the first predetermined state to the second predetermined state, and the second picture is displayed. As described above, the second picture is a communication interface of the communication application that includes the second image, wherein the second image, which is acquired by a second image acquisition unit of the second electronic apparatus, is received via the communication connection. In this case, the user interface is switched from the user interface 1001 shown in FIG. 10 into the user interface after the communication connection is established as described with reference to FIG. 8. Repeated description thereof will be omitted herein.

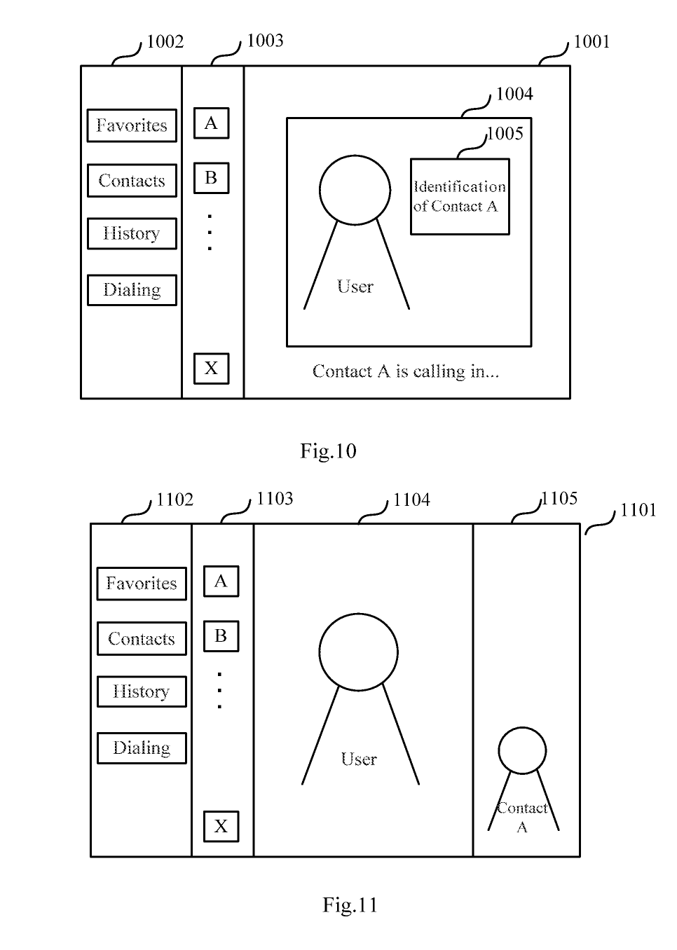

In addition, on the user interface shown in FIGS. 7, 8 and 10, the image of the local user and the identification or image of a counterpart of the video call are displayed in a manner of Picture-in-Picture. However, the present disclosure is not limited thereto, as shown in FIG. 11, the image of the local user and the identification of a counterpart of the video call may also be displayed in a tiled manner.

In the above, the electronic apparatus and the communication method thereof according to the embodiments of the present disclosure are described with reference to FIGS. 1 to 11. The electronic apparatus and the communication method thereof according to the embodiments of the present disclosure are capable of properly providing the users with an opportunity to adjust and confirm call conditions prior to establishing a video call connection between the two parties according to their needs, and thereby improving quality of pictures during the call after the video call connection is established, and enhancing user experience during the video call.

It should be noted that, in the specification, the terms “comprise”, “include” and any other variations thereof intend to cover non-exclusive inclusion so that the procedure, the method, the product or the equipment including a series of elements include not only these elements, but also other elements which are not listed explicitly, or also include inherent elements of the procedure, method, product or equipment. In the case that there is no further limitations, elements defined by the expressions “comprise one . . . ” do not exclude additional identity elements in the procedure, method, product, or equipment of the elements.

Finally, it should be noted that the above-described series of processes do not only comprise processes executed chronologically in the order mentioned here, and also comprise processes executed in parallel or individually but not chronologically.

Through the above description of the implementations, a person skilled in the art can clearly understand that the present disclosure may be implemented in a manner of software plus a necessary hardware platform, and of course, the present disclosure may also be implemented fully by hardware. Based on such understanding, the technical solution of the present disclosure that contributes to the background art may be embodied in whole or in part in the form of a software product. The computer software product may be stored in a storage medium, such as ROM/RAM, magnetic disk, optical disk which include several instructions for causing a computer apparatus (which may be a personal computer, a server, or a network device) to perform the method described in the various embodiments of the present disclosure or certain parts thereof.

Although the present disclosure has been described in detail in the above, specific examples are applied in this description to demonstrate the principles and implementations of the present disclosure. These descriptions of the embodiments above are only used to help those skilled in the art understand the method of the present disclosure and its core concept. Meanwhile, for those ordinary skilled in the art, depending on the concepts of the present disclosure, modifications may be made to the specific implementations and applications. To sum up, contents of this specification should not be construed as limiting the present disclosure.

What is claimed is:

1. A communication method for a first electronic apparatus including a first image acquisition unit, comprising:
monitoring a running state of the first electronic apparatus;
displaying a first picture that comprises a first image acquired by the first image acquisition unit when the running state satisfies a first predetermined state; and
establishing a communication connection with a second electronic apparatus and displaying a second picture when the running state is switched from the first predetermined state to a second predetermined state, the second picture including a second image acquired by a second image acquisition unit of the second electronic apparatus and received via the communication connection.

2. The communication method of claim 1, wherein monitoring a running state of the first electronic apparatus, and displaying a first picture when the running state satisfies the first predetermined state comprises:
detecting a first operation performed by a user of the first electronic apparatus, and starting a communication application when the first operation satisfies a startup condition for the communication application,
wherein the first picture is an initial interface of the communication application that includes the first image.

3. The communication method according to claim 2, further comprising:
detecting a second operation performed by the user after starting the communication application, the second operation for switching the running state from the first predetermined state to the second predetermined state.

4. The communication method of claim 1, wherein monitoring the running state of the first electronic apparatus, and displaying the first picture when the running state satisfies the first predetermined state comprises:
detecting a first operation performed by a user of the first electronic apparatus, and starting a communication application and displaying a third picture when the first operation satisfies a startup condition for the communication application; and
detecting a second operation performed by the user of the first electronic apparatus, sending a video call request to the second electronic apparatus and displaying the first picture when the second operation satisfies a communication request condition,
wherein the first picture is a communication request sending interface of the communication application that includes the first image, and the third picture is an initial interface of the communication application that does not include the first image.

5. The communication method of claim 4, further comprising:
after sending the video call request to the second electronic apparatus, detecting a reception of an acceptance response with respect to the video call request from the second electronic apparatus and switching the running state from the first predetermined state to the second predetermined state.

6. The communication method of claim 1, wherein monitoring the running state of the first electronic apparatus, and displaying the first picture when the running state satisfies the first predetermined state comprises:
detecting a first operation performed by a user of the first electronic apparatus, and starting a communication application and displaying a third picture when the first operation satisfies a startup condition for the communication application; and
detecting a reception of a video call request from the second electronic apparatus, and displaying the first picture,
wherein the first picture is a communication request receiving interface of the communication application that includes the first image, and the third picture is an initial interface of the communication application that does not include the first image.

7. The communication method of claim 1, further comprising:
detecting a third operation performed by the user of the first electronic apparatus after receiving the video call request from the second electronic apparatus, and switching the running state from the first predetermined state to the second predetermined state when the third operation indicates to accept the video call request.

8. The communication method of claim 1, wherein the first picture comprises a first sub-picture that displays the first image and a second sub-picture that displays an identification representative of a user of the second electronic apparatus.

9. The communication method of claim 8, wherein the second picture includes a third sub-picture that displays the second image and a fourth sub-picture that displays the first image.

10. The communication method of claim 9, wherein a region of the first sub-picture on the first picture and a region of the third sub-picture on the second picture are the same, and a region of the second sub-picture on the first picture and a region of the fourth sub-picture on the second picture are the same.

11. The communication method of claim 10, wherein a process that the first image enters a region to which the fourth sub-picture corresponds from a region to which the first sub-picture corresponds is displayed during the process of switching from the first predetermined state to the second predetermined state.

12. An electronic apparatus, comprising:
a processing unit for controlling various components of the electronic apparatus, and running applications and executing corresponding processes;
a communication unit for performing communication with another electronic apparatus via a communication connection;
an image acquisition unit for performing image acquisition under control of the processing unit; and
a display unit for performing display of an image or a video, wherein:
the processing unit monitors a running state of the first electronic apparatus, controls the display unit to display a first picture that includes a first image acquired by the first image acquisition unit when the running state satisfies a first predetermined state;
when the running state is switched from the first predetermined state to a second predetermined state, the communication unit establishes a communication connection with the another electronic apparatus, and displays a second picture that includes a second image acquired by a second image acquisition unit of the another electronic apparatus and received via the communication connection.

13. An electronic apparatus, comprising:
means for monitoring a running state of a first electronic apparatus;
means for displaying a first picture when the running state satisfies a first predetermined state, the first picture including a first image acquired by a first image acquisition unit; and
means for establishing a communication connection with a second electronic device and displaying a second picture when the running state is switched from the first predetermined state to a second predetermined state, the second picture including a second image acquired by a second image acquisition unit of the second electronic apparatus and received via the communication connection.

14. The electronic apparatus of claim 13, further comprising:
means for detecting a first operation performed by a user of the first electronic apparatus, and starting a communication application when the first operation satisfies a startup condition for the communication application,
wherein the first picture is an initial interface of the communication application that includes the first image.

15. The electronic apparatus of claim 13, further comprising:
means for detecting a first operation performed by a user of the first electronic apparatus, and starting a communication application and displaying a third picture when the first operation satisfies a startup condition for the communication application;
means for detecting a second operation performed by the user of the first electronic apparatus, and sending a video call request to the second electronic apparatus and displaying the first picture when the second operation satisfies a communication request condition,
wherein the first picture is a communication request sending interface of the communication application that includes the first image, and the third picture is an initial interface of the communication application that does not include the first image.

16. The electronic apparatus of claim 13, further comprising:
means for detecting a first operation performed by a user of the first electronic apparatus, and starting a communication application and displaying a third picture when the first operation satisfies a startup condition for the communication application;
means for detecting a reception of a video call request from the second electronic apparatus, and displaying the first picture,
wherein the first picture is a communication request receiving interface of the communication application that includes the first image, and the third picture is an initial interface of the communication application that does not include the first image.

17. The electronic apparatus of claim 13, wherein:
the first picture comprises a first sub-picture that displays the first image and a second sub-picture that displays an identification representative of a user of the second electronic apparatus;
the second picture includes a third sub-picture that displays the second image and a fourth sub-picture that displays the first image;
a region of the first sub-picture on the first picture and a region of the third sub-picture on the second picture are the same, and a region of the second sub-picture on the first picture and a region of the fourth sub-picture on the second picture are the same; and
a process that the first image enters a region to which the fourth sub-picture corresponds from a region to which the first sub-picture corresponds is displayed during the process of switching from the first predetermined state to the second predetermined state.

18. The electronic apparatus of claim 14, further comprising:
means for detecting a second operation performed by the user after starting the communication application, the second operation for switching the running state from the first predetermined state to the second predetermined state.

19. The electronic apparatus of claim 15, further comprising:
means for detecting a reception of an acceptance response with respect to the video call request from the second electronic apparatus after sending the video call request to the second electronic apparatus, and for switching the running state from the first predetermined state to the second predetermined state.

20. The electronic apparatus of claim 16, further comprising:
means for detecting a third operation performed by the user of the first electronic apparatus after receiving the video call request from the second electronic apparatus, and for switching the running state from the first predetermined state to the second predetermined state when the third operation indicates to accept the video call request.
